(19) United States
(12) Patent Application Publication
(10) Pub. No.: US 2018/0056541 A1
(43) Pub. Date: Mar. 1, 2018

(54) CUTTING MACHINE

(71) Applicant: PATHFINDER CO., LTD., Keelung City (TW)

(72) Inventor: Max Winfried Alexander Spitznagel, Los Angeles, CA (US)

(21) Appl. No.: 15/677,765

(22) Filed: Aug. 15, 2017

(30) Foreign Application Priority Data
Aug. 31, 2016 (TW) 105213396

(51) Int. Cl. B27B 27/10; B27B 31/06

(52) U.S. Cl. CPC B27B 27/10; B27B 5/29; B27B 31/06

(57) ABSTRACT

A cutting machine includes a machine body, a blade, a support, a movable frame and a fastener. The blade is disposed on the machine body, and the blade is rotatable relative to the machine body. The support is fixed to the machine body. The movable frame includes a slidable member and a blocking member. The slidable member is slidably disposed on the support, and the slidable member has a guide slot. The fastener is disposed through the guide slot. The movable frame is slidable relative to the support to have a plurality of blocking positions.

### CROSS-REFERENCE TO RELATED APPLICATIONS

This non-provisional application claims priority under 35 U.S.C. §119(a) to Patent Application No(s). 105213396 filed in Taiwan R.O.C. on Aug. 31, 2016, the entire contents of which are hereby incorporated by reference.

### TECHNICAL FIELD

The present disclosure provides a cutting machine, more particularly to a cutting machine having a movable frame.

### BACKGROUND

A cutting machine, such as pneumatic circular saw, is adapted for cutting materials by using air to rotate the circular saw in a high speed. Generally, a block is disposed on the cutting machine, and an end of a material is abutted against the block, such that the material can be quickly cut into several pieces having the same size.

For a conventional configuration of the block and the cutting machine, there are multiple threaded holes formed on the cutting machine, and a screw can be screwed into one of the threaded holes. There is a distance between each of the threaded holes and the circular saw, and the distances are different from each other. The block is fixed to one of the threaded holes by a screw and can be moved to be fixed to another threaded hole, such that the size of the piece of the material, which is cut by the circular saw, can be changed.

### SUMMARY

According to one aspect of the present disclosure, a cutting machine includes a machine body, a blade, a support, a movable frame and a fastener. The blade is disposed on the machine body, and the blade is rotatable relative to the machine body. The support is fixed to the machine body. The movable frame includes a slidable member and a blocking member. The slidable member is slidably disposed on the support, and the slidable member has a guide slot. The fastener is disposed through the guide slot. The movable frame is slidable relative to the support to have a plurality of blocking positions.

### BRIEF DESCRIPTION OF THE DRAWINGS

The present disclosure will become more understood from the detailed description given herein below and the accompanying drawings which are given by way of illustration only and thus are not limitative of the present disclosure and wherein:

FIG. 1 is a perspective view of a cutting machine according to a first embodiment;

FIG. 2 is an exploded view of the cutting machine in FIG. 1;

FIG. 3 is a side view of the cutting machine in FIG. 1;

FIG. 4 is a schematic view of usage of the cutting machine in FIG. 1; and

FIG. 5 is a side view of a cutting machine according to a second embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

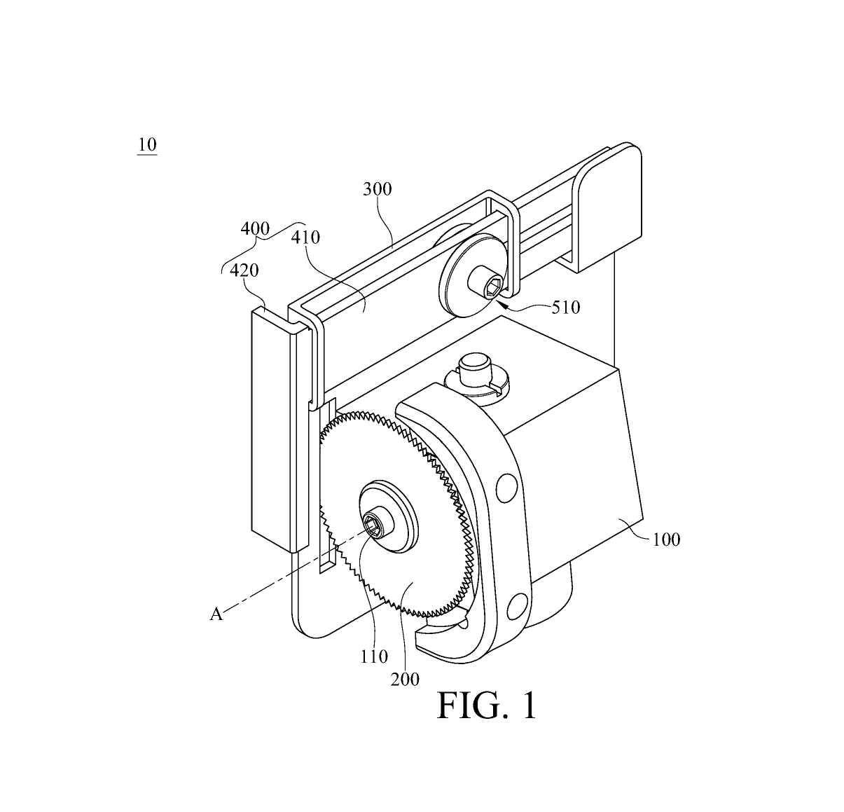

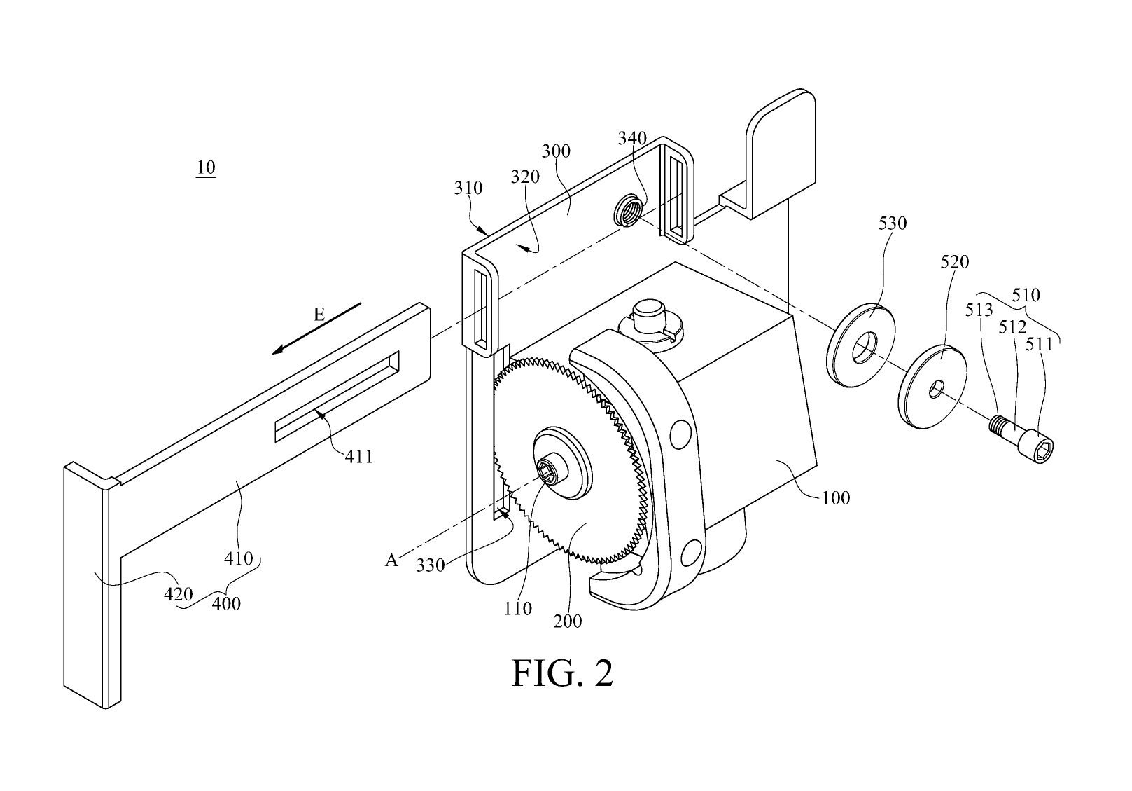

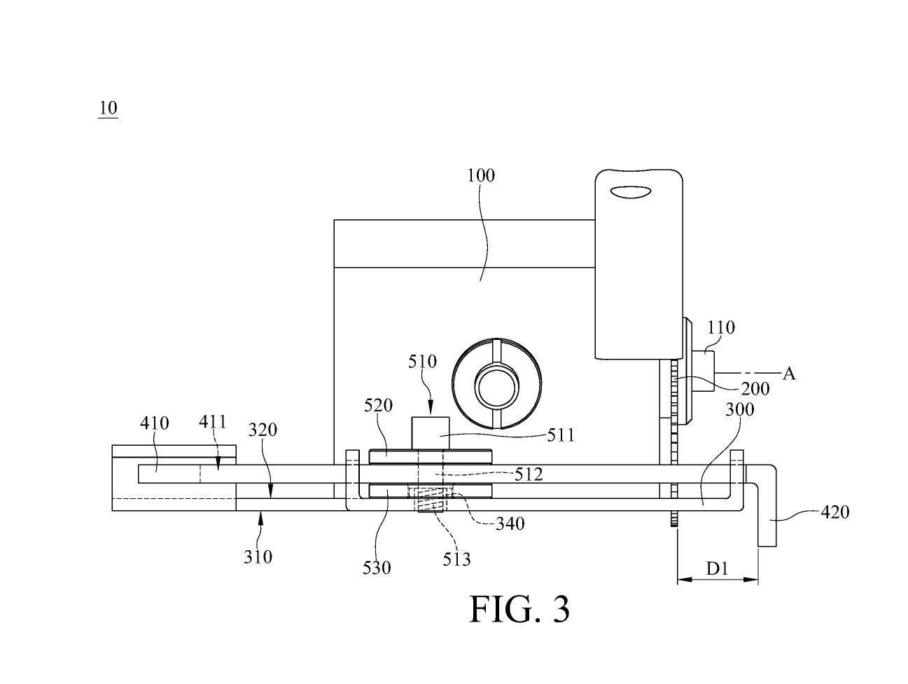

Please refer to FIG. 1 to FIG. 3. FIG. 1 is a perspective view of a cutting machine according to a first embodiment. FIG. 2 is an exploded view of the cutting machine in FIG. 1. FIG. 3 is a side view of the cutting machine in FIG. 1. The first embodiment is chosen as one exemplary reference in order to properly explain the principles of the disclosure and its practical applications, to thereby enable a person skilled in the art to better utilize the disclosure. The cutting machine of the disclosure is not limited to the specific form disclosed in the first embodiment and the appended drawings. Any limitation disclosed in the first embodiment is possible to be modified or varied in view of the following teachings.

In this embodiment, a cutting machine 10 including a machine body 100, a blade 200, a support 300, a movable frame 400 and a fastener 510 is disclosed. The blade 200 is disposed on the machine body 100, and the blade 200 is rotatable relative to the machine body 100. In detail, the machine body 100 has a shaft 110, and the blade 200 is fixed to the shaft 110. When gas flows into the machine body 100, the blade 200 is rotated around a rotation axis A to cut a material (not shown in the drawings). The material cut by the cutting machine 10, for example, is a wood board or a metal bar.

The support 300 is fixed to the machine body 100 by, for example, a screw. The support 300 has an abutting surface 310 and a rear surface 320 opposite to each other. The machine body 100 is attached to the rear surface 320. Furthermore, the support 300 further has an opening 330 and a hole 340. Both the opening 330 and the hole 340 extend through the support 300, wherein two opposite ends of the opening 330 are respectively located on the abutting surface 310 and the rear surface 320, and two opposite ends of the hole 340 are respectively located on the abutting surface 310 and the rear surface 320. A part of the blade 200 is located in the opening 330 and protrudes from the abutting surface 310. The present disclosure is not limited to the opening 330 in this embodiment. In some embodiments, there is no opening on the support.

The movable frame 400 includes a slidable member 410 and a blocking member 420 connected to each other. The slidable member 410 is disposed near the rear surface 320, and the blocking member 420 protrudes from the abutting surface 310 of the support 300. The slidable member 410 is disposed on the support 300, and the slidable member 410 is slidable relative to the support 300. In this embodiment, the slidable member 410 has a guide slot 411 having a rectangular shape, and an extension direction E of the guide slot 411 is substantially parallel to the rotation axis A of the blade 200.

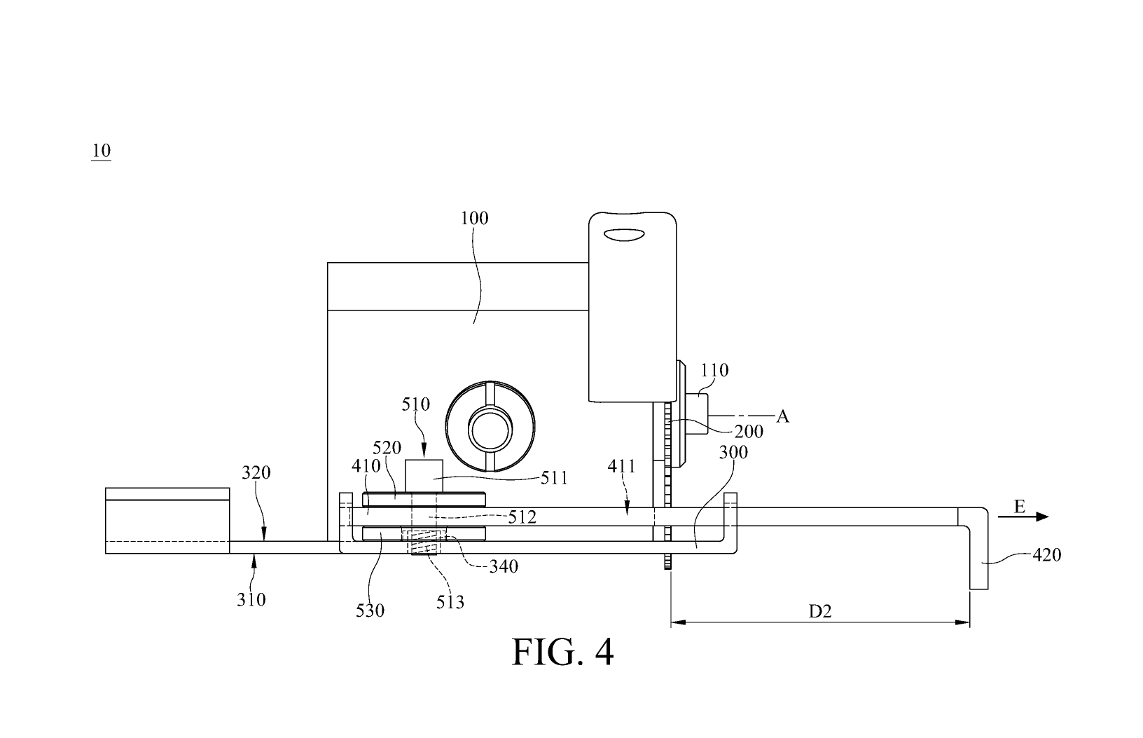

The fastener 510 is disposed through the guide slot 411. As shown in FIG. 3 and FIG. 4, the movable frame 400 is slidable relative to the support 300 along the extension direction E of the guide slot 411 to have a plurality of blocking positions. The distance between the movable blocking member 420 and the blade 200 is adjustable by moving the movable frame 400.

In this embodiment, the fastener 510 includes a pressing part 511, an extension part 512, and a thread part 513. The pressing part 511 and the thread part 513 are respectively connected to two opposite ends of the extension part 512. The pressing part 511 protrudes from the periphery of the extension part 512. The thread part 513 is screwed on the support 300; in this embodiment, the thread part 513 is screwed into the hole 340 on the support 300. When the thread part 513 is screwed into the hole 340, the extension part 512 is disposed through the guide slot 411, and the pressing part 511 is driven to press the slidable member 410 of the movable frame 400, the movable frame 400 is positioned at one of the blocking positions.

In this embodiment, the cutting machine 10 further includes a first washer 520 and a second washer 530. As shown in FIG. 1 and FIG. 2, the first washer 520 is sandwiched between the pressing part 511 and the slidable member 410, and the second washer 530 is sandwiched between the slidable member 410 and the support 300. Therefore, it is favorable for the fastener 510 to be firmly fastened to the support 300 and the slidable member 410.

Please refer to FIG. 3 and FIG. 4. FIG. 4 is a schematic view of usage of the cutting machine in FIG. 1. As shown in FIG. 3, the movable frame 400 is at a first blocking position, and there is a first distance D1 between the blocking member 420 of the movable frame 400 and the blade 200. When the material is abutted against the blocking member 420, the material is able to be cut by the blade 200, such that a piece of the material having a size equal to the first distance D1 is obtained.

As shown in FIG. 4, when the user wants to change the size of the piece of the material, the fastener 510 is released, and the movable frame 400 is pulled along the direction E to be at a second blocking position, such that the distance between the blocking member 420 and the blade 200 is changed from the first distance D1 to the second distance D2. When the material is abutted against the blocking member 420, the material is able to be cut by the blade 200, such that a piece of the material having a size equal to the first distance D2 is obtained.

The blocking position of the movable frame 400 is changeable by the arrangement of the guide slot 411 and the fastener 510. Therefore, the distance between the blocking member 420 of the movable frame 400 and the blade 200 is able to be adjusted seamlessly for satisfying the requirement of a customized size of the piece of the material.

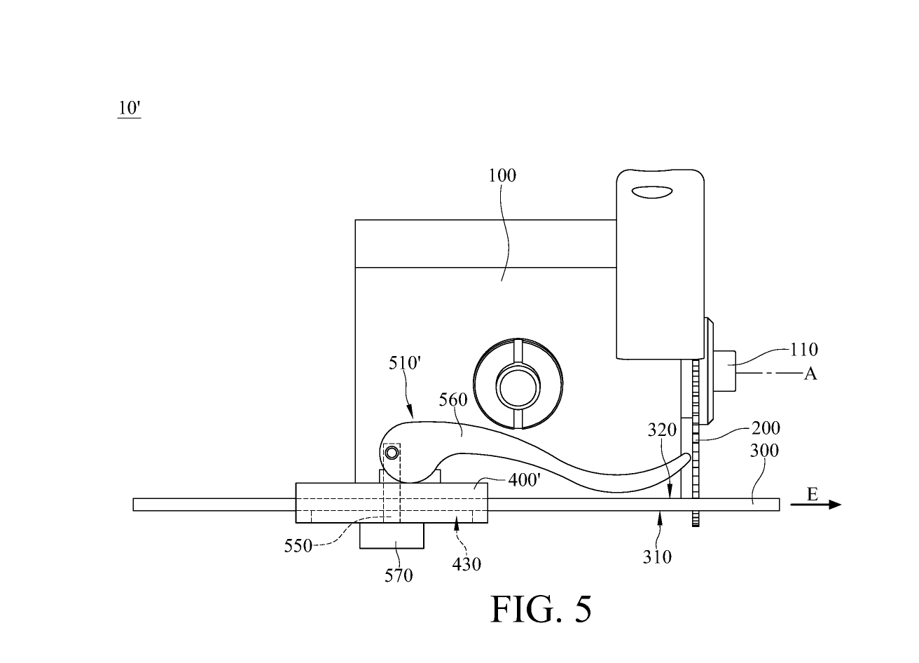

Please refer to FIG. 5. FIG. 5 is a side view of a cutting machine according to a second embodiment. Since the second embodiment is similar to the first embodiment, only some differences between the first and the second embodiments are illustrated hereafter. The second embodiment is also chosen as one exemplary reference in order to properly explain the principles of the disclosure and its practical applications, to thereby enable a person skilled in the art to better utilize the disclosure. The cutting machine of the disclosure is not limited to the specific form disclosed in the second embodiment and the appended drawings. Any limitation disclosed in the second embodiment is possible to be modified or varied in view of the following teachings.

In this embodiment, a cutting machine 10′ including a machine body 100, a blade 200, a support 300, a movable frame 400′ and a fastener 510′ is provided. The blade 200 is disposed on the machine body 100, and the blade 200 is rotatable relative to the machine body 100. The support 300 is fixed to the machine body 100 by, for example, a screw, and the support 300 has an abutting surface 310 and a rear surface 320 opposite to each other. The movable frame 400′ is disposed on the support 300, and the movable frame 400′ is slidably disposed on the support 300, and the movable frame 400′ protrudes from the abutting surface 310. The movable frame 400′ has a guide slot 430 having a rectangular shape, and the extension direction E of the guide slot 430 is substantially parallel to the rotation axis A of the blade 200.

In this embodiment, the fastener 510′ includes a rod 550, a handle 560 and a head 570. The rod 550 is disposed through the guide slot 430, and one end of the rod 550 is fixed to the head 570. The handle 560 is pivoted on another end of the rod 550. The handle 560 is able to be pivoted to press the movable frame 400′ so as to position the movable frame 400′ at one of the blocking positions.

According to the disclosure, the blocking position of the movable frame is changeable by the arrangement of the guide slot and the fastener. Therefore, the distance between the blocking member of the movable frame and the blade is able to be adjusted seamlessly for satisfying the requirement of a customized size of the piece of the material.

What is claimed is:

1. A cutting machine, comprising:
a machine body;
a blade disposed on the machine body, and the blade being rotatable relative to the machine body,
a support fixed to the machine body;
a movable frame comprising a slidable member and a blocking member, the slidable member slidably disposed on the support, and the slidable member having a guide slot; and
a fastener disposed through the guide slot, and the movable frame being slidable relative to the support to have a plurality of blocking positions.

2. The cutting machine according to claim 1, wherein the fastener comprises a pressing part, an extension part and a thread part, the pressing part and the thread part are respectively connected to two ends of the extension part opposite to each other;
wherein the slidable member is pressed against the pressing part, the extension part is disposed through the guide slot, and the thread part is screwed on the support, such that the movable frame is positioned at one of the plurality of blocking positions.

3. The cutting machine according to claim 2, further comprising a first washer disposed between the pressing part and the slidable member of the movable frame.

4. The cutting machine according to claim 3, further comprising a second washer disposed between the slidable member of the movable frame and the support.

5. The cutting machine according to claim 1, wherein the fastener comprises a rod, a handle, and a head, the rod is disposed through the guide slot, one end of the rod is fixed to the head, the handle is pivoted on another end of the rod, and the movable frame is pressed against the handle to be at one of the plurality of blocking positions.

6. The cutting machine according to claim 1, wherein the support has an abutting surface and a rear surface opposite to each other, the machine body is attached to the rear surface, the slidable member of the movable frame is disposed near the rear surface, and the blocking member of the movable frame protrudes from the abutting surface of the support.

7. The cutting machine according to claim 6, wherein the support has an opening, a part of the blade is disposed in the opening and protrudes from the abutting surface.

8. The cutting machine according to claim 1, wherein the blade is rotatable around a rotation axis, and an extension direction of the guide slot is substantially parallel to the rotation axis of the blade.

9. The cutting machine according to claim 1, wherein the guide slot has a rectangular shape.
